(19) United States
(12) Patent Application Publication
(10) Pub. No.: US 2009/0218222 A1
(43) Pub. Date: Sep. 3, 2009

(54) Free flow electrophoresis microchip, system and method

(76) Inventors: Andreas Manz, Dortmund (DE); Chao-Xuan Zhang, Salt Lake City, UT (US)

Correspondence Address: PERMAN & GREEN, 425 POST ROAD, FAIRFIELD, CT, 06824, US

(21) Appl. No.: 10/559,958

(22) PCT Filed: Jun. 8, 2004
(86) PCT No.: PCT/GB04/02423

§ 371 Date: Jun. 30, 2006

(30) Foreign Application Priority Data
Jun. 9, 2003 (GB) 0313197.6

(51) Int. Cl. G01N 27/447; C25B 9/00

(52) U.S. Cl. 204/545; 204/600

(57) ABSTRACT

The present invention relates to a free flow electrophoresis microchip for the electrophoretic separation of charged components, a free flow electrophoresis separation system incorporating the same, and a free flow electrophoresis method of separating charged components, the microchip comprising: a separation chamber in which charged components are in use separated; a plurality of separation medium inlet channels having outlets fluidly connected to one, inlet side of the separation chamber through which flows of a separation medium are in use introduced into the separation chamber such as to develop a laminar flow having a flow direction through the separation chamber; a sample inlet channel having an outlet fluidly connected to the inlet side of the separation chamber through which a flow of a sample containing charged components is in use introduced into the separation chamber; a plurality of outlet channels having inlets fluidly connected to another, outlet side of the separation chamber opposite the inlet side thereof; and a magnetic field unit for providing a magnetic field substantially orthogonal to the flow direction of the separation medium; whereby charged components introduced into the separation chamber are deflected laterally across the separation chamber in dependence upon the charge, typically the electrophoretic mobilities or the iso-electric points, of the charged components.

The present invention relates to a free flow electrophoresis microchip for the electrophoretic separation of charged components, typically ranging in size from molecular to cellular dimensions and in dependence upon the electrophoretic mobilities (EPMs) or the iso-electric points (pIs) of the charged components, a free flow electrophoresis separation system incorporating the same, and a free flow electrophoresis method of separating charged components.

The present inventors have recognized that the provision of orthogonal magnetic and electric fields in a free flow electrophoresis microchip, which utilizes an electrolyte medium as the separation medium, provides for a magnetohydrodynamic flow of sample and separation medium to the separation chamber, thereby avoiding the need for a separate delivery mechanism for the delivery of sample and separation medium, and also that the provision of a magnetic field in a direction orthogonal to the flow direction through the separation chamber of a free flow electrophoresis microchip, which utilizes an electrolyte medium as the separation medium, induces an electric field transverse to the separation chamber, thereby avoiding the need for a separate high-voltage supply to provide an electric field.

In one aspect the present invention provides a free flow electrophoresis microchip, comprising: a separation chamber in which charged components are in use separated; a plurality of separation medium inlet channels having outlets fluidly connected to one, inlet side of the separation chamber through which flows of a separation medium are in use introduced into the separation chamber such as to develop a laminar flow having a flow direction through the separation chamber; a sample inlet channel having an outlet fluidly connected to the inlet side of the separation chamber through which a flow of a sample containing charged components is in use introduced into the separation chamber; a plurality of outlet channels having inlets fluidly connected to another, outlet side of the separation chamber opposite the inlet side thereof; and a magnetic field unit for providing a magnetic field substantially orthogonal to the flow direction of the separation medium; whereby charged components introduced into the separation chamber are deflected laterally across the separation chamber in dependence upon the charge, typically the electrophoretic mobilities or the iso-electric points, of the charged components.

Preferably, the outlets of the separation medium inlet channels are disposed in spaced relation along the inlet side of the separation chamber.

In one embodiment the outlet of the sample inlet channel is disposed in a central region of the inlet side of the separation chamber.

In another embodiment the outlet of the sample inlet channel is disposed in an end region of the inlet side of the separation chamber.

Preferably, the outlets of the sample inlet channel and the separation medium inlet channels face in the same direction.

In one embodiment the separation medium inlet channels are commonly fluidly connected.

In another embodiment groups of ones of the separation medium inlet channels are commonly fluidly connected.

In a further embodiment the separation medium inlet channels are separately fluidly connected.

Preferably, the outlets of the sample inlet channel and the separation medium inlet channels are disposed in opposed relation to the inlets of the outlet channels.

Preferably, the inlets of the outlet channels have a depth at least as great as that of the separation chamber.

Preferably, the inlets of the outlet channels are disposed in spaced relation along the outlet side of the separation chamber.

More preferably, the inlets of the outlet channels are equi-spaced.

Preferably, the separation chamber comprises a planar chamber having a planar region.

More preferably, the magnetic field is directed substantially orthogonally to the planar region of the separation chamber.

More preferably, the separation chamber has a depth of from about 5 μm to about 50 μm.

Preferably, the magnetic field unit comprises at least one magnet.

More preferably, the at least one magnet comprises a layer of magnetic material.

Yet more preferably, the magnetic material comprises a Ni—Fe permalloy.

In one embodiment the microchip further comprises: first and second electrode units disposed at respective ones of other, lateral sides of the separation chamber.

Preferably, the electrode units each comprise an electrolyte reservoir disposed adjacent the respective lateral side of the separation chamber for containing a volume of an electrolyte medium, and a plurality of connection channels fluidly connecting the electrolyte reservoir to the respective lateral side of the separation chamber.

More preferably, each electrolyte reservoir has substantially the same length as the separation chamber.

More preferably, the connection channels are disposed in spaced relation along the respective lateral sides of the separation chamber.

Yet more preferably, the connection channels are equi-spaced.

More preferably, the connection channels have a width of from about 1 μm to about 5 μm.

More preferably, the electrode units each further comprise an electrode element disposed in the respective electrolyte reservoir.

In one embodiment the present invention extends to a free flow electrophoresis separation system, comprising: the above-described free flow electrophoresis microchip; and a high-voltage supply for applying an electric field between the electrode units and across the separation chamber in a direction substantially orthogonal to the magnetic field; whereby a magnetohydrodynamic flow of sample and separation medium is induced through the separation chamber.

In another embodiment the present invention extends to a free flow electrophoresis separation system, comprising: the above-described free flow electrophoresis microchip; and a supply unit for supplying flows of sample and separation medium through the respective ones of the sample inlet channel and the separation medium inlet channels and into the separation chamber; whereby an electric field is induced across the separation chamber in a direction substantially orthogonal to the flow direction.

Preferably, the supply unit comprises a first transfer unit fluidly connected to the sample inlet channel for delivering a flow of sample through the sample inlet channel and into the separation chamber, and at least one second transfer unit fluidly connected to the separation medium inlet channels for delivering flows of separation medium through the separation medium inlet channels and into the separation chamber.

More preferably, at least one of the first transfer unit and the at least one second transfer unit are operable to control flow rates of the sample and separation medium flows to the separation chamber.

More preferably, the at least one second transfer unit comprises a plurality of second transfer units fluidly connected to respective ones of the separation medium inlet channels.

In one embodiment the plurality of second transfer units are fluidly connected to groups of ones of the separation medium inlet channels.

In another embodiment the plurality of second transfer units are fluidly connected to separate ones of the separation medium inlet channels.

In one embodiment each transfer unit comprises a delivery pump.

Preferably, the system further comprises: at least one collection unit fluidly connected to at least one of the outlet channels for collection of at least one separated component.

More preferably, the system further comprises: a plurality of collection units fluidly connected to respective ones of the outlet channels for collection of a plurality of separated components.

Preferably, the system further comprises: a detection unit for detecting migration of at least one separated component through at least one of the outlet channels.

More preferably, the detection unit is configured to detect migration of separated components through a plurality of ones of the outlet channels.

Yet more preferably, the detection unit is configured to detect migration of separated components through each of the outlet channels.

In another aspect the present invention provides a free flow electrophoresis method of separating charged components, the method comprising the steps of: providing a free flow electrophoresis microchip, comprising: a separation chamber in which charged components are separated; a plurality of separation medium inlet channels having outlets fluidly connected to one, inlet side of the separation chamber; a sample inlet channel having an outlet fluidly connected to the inlet side of the separation chamber; a plurality of outlet channels having inlets fluidly connected to another, outlet side of the separation chamber opposite the inlet side thereof; a magnetic field unit for providing a magnetic field in a direction substantially orthogonal to the flow direction of the separation medium; and first and second electrode units disposed at respective ones of other, lateral sides of the separation chamber; and applying a potential between the electrode units so as to generate an electric field across the separation chamber in a direction substantially orthogonal to the magnetic field direction, wherein the electric field acts together with the magnetic field to induce a magnetohydrodynamic flow of sample and separation medium through the separation chamber, and deflect the charged components laterally across the separation chamber in dependence upon the charge, typically the electrophoretic mobilities or the iso-electric points, of the charged components.

Preferably, the outlets of the separation medium inlet channels are disposed in spaced relation along the inlet side of the separation chamber.

In one embodiment the outlet of the sample inlet channel is disposed in a central region of the inlet side of the separation chamber.

In another embodiment the outlet of the sample inlet channel is disposed in an end region of the inlet side of the separation chamber.

Preferably, the outlets of the sample inlet channel and the separation medium inlet channels face in the same direction.

In one embodiment the method further comprises the step of: commonly introducing separation medium through the separation medium inlet channels.

In another embodiment the method further comprises the step of: introducing different separation media through respective groups of ones of the separation medium inlet channels.

In a further embodiment the method further comprises the step of: introducing different separation media through respective ones of the separation medium inlet channels.

Preferably, the outlets of the sample inlet channel and the separation medium inlet channels are disposed in opposed relation to the inlets of the outlet channels.

Preferably, the inlets of the outlet channels have a depth at least as great as that of the separation chamber.

Preferably, the inlets of the outlet channels are disposed in spaced relation along the outlet side of the separation chamber.

More preferably, the inlets of the outlet channels are equi-spaced.

Preferably, the separation chamber comprises a planar chamber having a planar region.

More preferably, the magnetic field direction is in a direction substantially orthogonal to the planar region of the separation chamber.

More preferably, the separation chamber has a depth of from about 5 μm to about 50 μm.

Preferably, the magnetic field unit comprises at least one magnet.

More preferably, the at least one magnet comprises a layer of magnetic material.

Yet more preferably, the magnetic material comprises a Ni—Fe permalloy.

Preferably, the electrode units each comprise an electrolyte reservoir disposed adjacent the respective lateral side of the separation chamber for containing a volume of an electrolyte medium, and a plurality of connection channels fluidly connecting the electrolyte reservoir to the respective lateral side of the separation chamber.

More preferably, each electrolyte reservoir has substantially the same length as the separation chamber.

More preferably, the connection channels are disposed in spaced relation along the respective lateral sides of the separation chamber.

Yet more preferably, the connection channels are equi-spaced.

More preferably, the connection channels have a width of from about 1 μm to about 5 μm.

More preferably, the electrode units each further comprise an electrode element disposed in the respective electrolyte reservoir.

Preferably, the method further comprises the step of: collecting at least one separated component from at least one of the outlet channels.

More preferably, the step of collecting at least one separated component comprises the step of: collecting a plurality of separated components from respective ones of the outlet channels.

Preferably, the method further comprises the step of: detecting migration of at least one separated component through at least one of the outlet channels.

More preferably, the step of detecting migration of at least one separated component comprises the step of: detecting migration of separated components through a plurality of ones of the outlet channels.

Yet more preferably, the step of detecting migration of at least one separated component comprises the step of: detecting migration of separated components through each of the outlet channels.

In a further aspect the present invention provides a free flow electrophoresis method of separating charged components, the method comprising the steps of: providing a free flow electrophoresis microchip, comprising: a separation chamber in which charged components are separated; a plurality of separation medium inlet channels having outlets fluidly connected to one, inlet side of the separation chamber; a sample inlet channel having an outlet fluidly connected to the inlet side of the separation chamber; a plurality of outlet channels having inlets fluidly connected to another, outlet side of the separation chamber opposite the inlet side thereof; and a magnetic field unit for providing a magnetic field in a direction substantially orthogonal to the flow direction of the separation medium; and supplying flows of sample and separation medium through the respective ones of the sample inlet channel and the separation medium inlet channels into and through the separation chamber, wherein the flow of separation medium acts together with the magnetic field to induce an electric field across the separation chamber in a direction substantially orthogonal to the flow direction, which electric field acts to deflect the charged components laterally across the separation chamber in dependence upon the charge, typically the electrophoretic mobilities or the iso-electric points, of the charged components.

Preferably, the outlets of the separation medium inlet channels are disposed in spaced relation along the inlet side of the separation chamber.

In one embodiment the outlet of the sample inlet channel is disposed in a central region of the inlet side of the separation chamber.

In another embodiment the outlet of the sample inlet channel is disposed in an end region of the inlet side of the separation chamber.

Preferably, the outlets of the sample inlet channel and the separation medium inlet channels face in the same direction.

In one embodiment the step of supplying sample and separation medium includes the step of: commonly supplying separation medium through the separation medium inlet channels.

In another embodiment the step of supplying sample and separation medium includes the step of: supplying different separation media through respective groups of ones of the separation medium inlet channels.

In a further embodiment the step of supplying sample and separation medium includes the step of: supplying different separation media through respective ones of the separation medium inlet channels.

In one embodiment the step of supplying sample and separation medium comprises the step of: delivering sample and separation medium flows through the respective ones of the sample inlet channel and the separation medium inlet channels and into the separation chamber.

Preferably, flow rates of the sample and separation medium flows are regulated to control the lateral deflection of the charged components.

Preferably, the outlets of the sample inlet channel and the separation medium inlet channels are disposed in opposed relation to the inlets of the outlet channels.

Preferably, the inlets of the outlet channels have a depth at least as great as that of the separation chamber.

Preferably, the inlets of the outlet channels are disposed in spaced relation along the outlet side of the separation chamber.

More preferably, the inlets of the outlet channels are equi-spaced.

Preferably, the separation chamber comprises a planar chamber having a planar region.

Preferably, the magnetic field direction is in a direction substantially orthogonal to the planar region of the separation chamber.

Preferably, the separation chamber has a depth of from about 5 μm to about 50 μm.

Preferably, the magnetic field unit comprises at least one magnet.

More preferably, the at least one magnet comprises a layer of magnetic material.

Yet more preferably, the magnetic material comprises a Ni—Fe permalloy.

Preferably, the microchip further comprises: first and second electrode units disposed at respective ones of other, lateral sides of the separation chamber.

More preferably, the electrode units each comprise an electrolyte reservoir disposed adjacent the respective lateral side of the separation chamber for containing a volume of an electrolyte medium, and a plurality of connection channels fluidly connecting the electrolyte reservoir to the respective lateral side of the separation chamber.

Yet more preferably, each electrolyte reservoir has substantially the same length as the separation chamber.

Preferably, the connection channels are disposed in spaced relation along the respective lateral sides of the separation chamber.

More preferably, the connection channels are equi-spaced.

Preferably, the connection channels have a width of from about 1 μm to about 5 μm.

Preferably, the electrode units each further comprise an electrode element disposed in the respective electrolyte reservoir.

Preferably, the method further comprises the step of: collecting at least one separated component from at least one of the outlet channels.

More preferably, the step of collecting at least one separated component comprises the step of: collecting separated components from respective ones of the outlet channels.

Preferably, the method further comprises the step of: detecting migration of at least one separated component through at least one of the outlet channels.

More preferably, the step of detecting migration of at least one separated component comprises the step of: detecting migration of separated components through a plurality of ones of the outlet channels.

Yet more preferably, the step of detecting migration of at least one separated component comprises the step of: detecting migration of separated components through each of the outlet channels.

Preferred embodiments of the present invention will now be described hereinbelow by way of example only with reference to the accompanying drawings, in which:

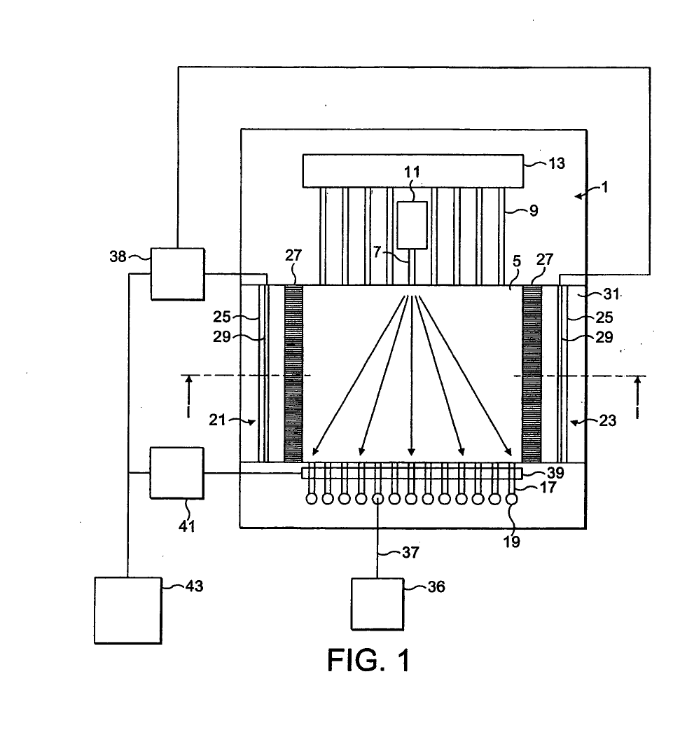

FIG. 1 schematically illustrates a free flow electrophoresis separation system in accordance with a first embodiment of the present invention;

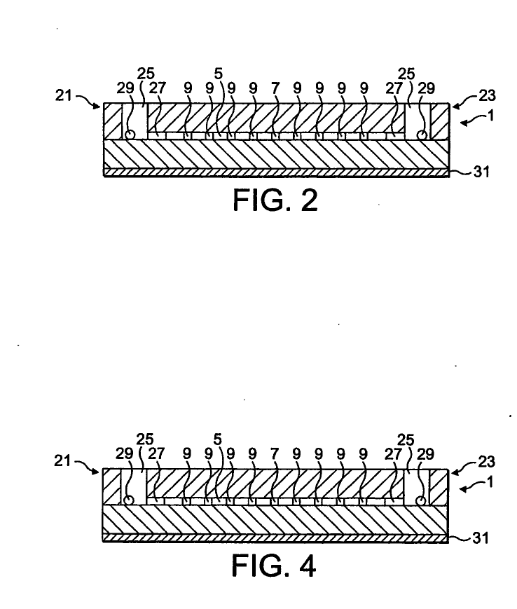

FIG. 2 illustrates a vertical sectional view (along section I-I) of the free flow electrophoresis microchip of the separation system of FIG. 1;

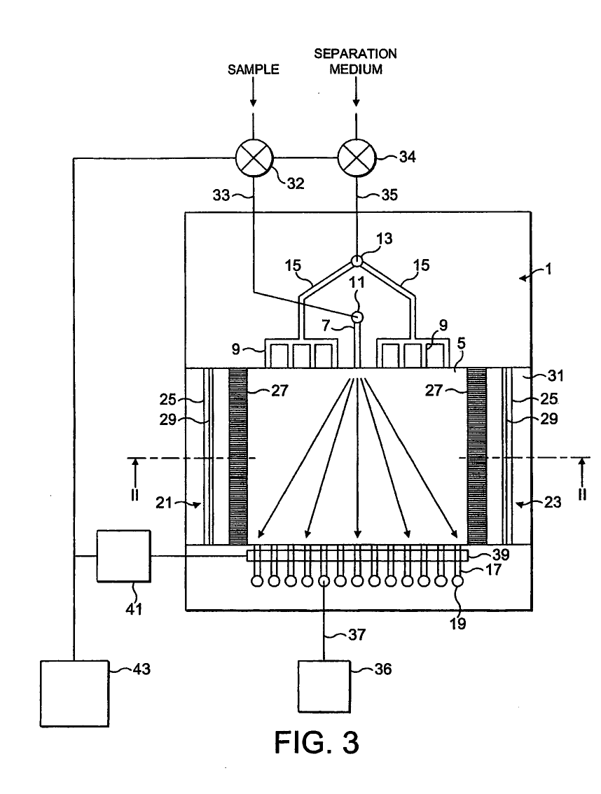

FIG. 3 schematically illustrates a free flow electrophoresis separation system in accordance with a second embodiment of the present invention;

FIG. 4 illustrates a vertical sectional view (along section II-II) of the free flow electrophoresis microchip of the separation system of FIG. 3;

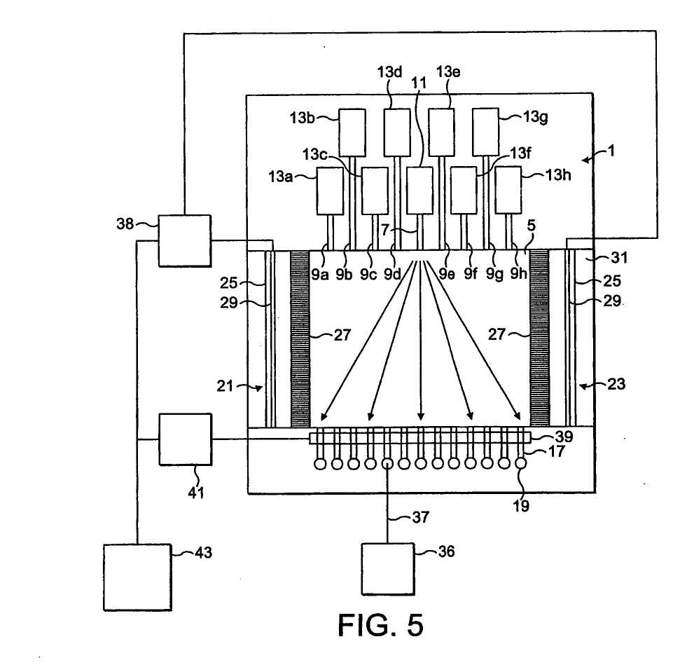

FIG. 5 schematically illustrates a free flow electrophoresis separation system as a modification of the first embodiment of the present invention; and

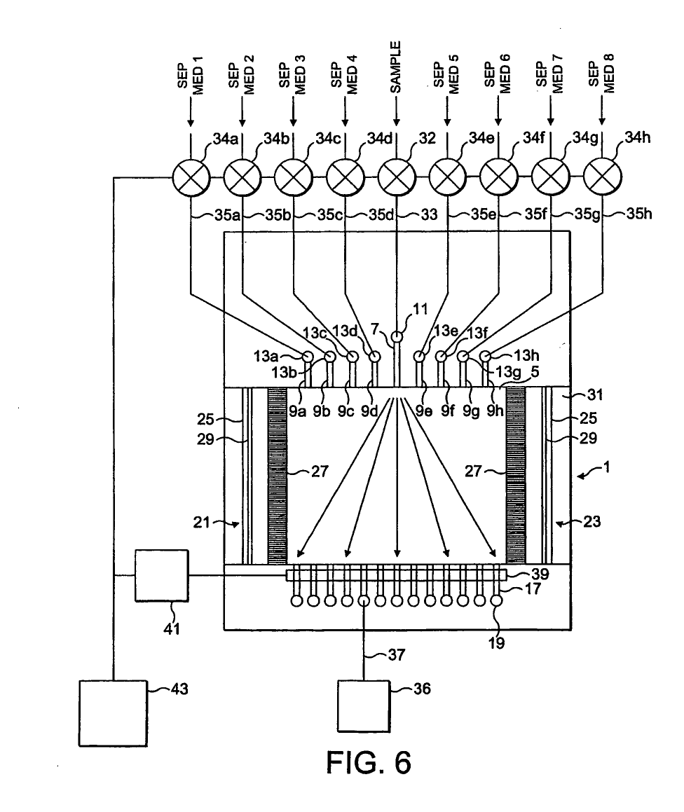

FIG. 6 schematically illustrates a free flow electrophoresis separation system as a modification of the second embodiment of the present invention.

FIGS. 1 and 2 illustrate a free flow electrophoresis separation system in accordance with a first embodiment of the present invention.

The separation system comprises a free flow electrophoresis (FFE) microchip 1 into which a sample containing charged components is introduced for the electrophoretic separation of the charged components, with the separation being in dependence upon the electrophoretic mobilities of the charged components.

The FFE microchip 1 includes a free flow separation chamber 5, in this embodiment a planar chamber of rectangular section and having a width of 14 mm, a length of 20 mm and a depth of 20 μm, in which a laminar flow of a separation medium is maintained and a sample containing charged components is introduced for electrophoretic separation. In this embodiment the separation chamber 5 includes a plurality of regularly-spaced posts, here 20 μm square, which act to support the structure of the separation chamber 5. In other embodiments the separation chamber 5 can have a depth of from about 5 μm to about 50 μm.

The FFE microchip 1 further includes a plurality of parallel inlet channels 7, 9, in this embodiment each having a width of 20 μm and a depth of 20 μm, the outlets of which are fluidly connected to one, inlet side of the separation chamber 5. One of the inlet channels 7, 9 defines a sample inlet channel 7 through which a flow of a sample containing charged components is introduced into the separation chamber 5. The others of the inlet channels 7, 9 define separation medium inlet channels 9, the outlets of which are in this embodiment equi-spaced, through which parallel flows of a separation medium are introduced into the separation chamber 5, thereby developing a laminar flow having a first, flow direction through the separation chamber 5. In this embodiment the sample inlet channel 7 is a channel central to the separation chamber 5, with ones of the separation medium inlet channels 9 being disposed to adjacent sides of the sample inlet channel 7.

As illustrated diagrammatically in FIG. 1, this configuration enables the separation of differently-charged components. In the separation of electrically-charged components, positively-charged components are deflected laterally to one lateral side, the cathode, relative to the flow of sample and negatively-charged components are deflected laterally to the other lateral side, the anode, relative to the flow of sample.

In another embodiment the sample inlet channel 7 could be disposed to one end of the inlet side of the separation chamber 5; this configuration being suited to applications where the components to be separated have one of a positive or negative charge, and hence are deflected only to one side of the flow of sample.

The FFE microchip 1 further includes a sample reservoir 11 for containing a volume of a sample containing charged components to which the sample inlet channel 7 is fluidly connected, and a separation medium reservoir 13 for containing a volume of a separation medium, in this embodiment an electrolyte solution, to which the separation medium inlet channels 9 are commonly fluidly connected.

The FFE microchip 1 further includes a plurality of outlet channels 17, in this embodiment having a width of 20 μm and a depth of 20 μm, the inlets of which are fluidly connected to another, outlet side of the separation chamber 5 disposed opposite the inlet side of the separation chamber 5 to which the inlet channels 7, 9 are fluidly connected. In this embodiment the inlets of the outlet channels 17 are equi-spaced.

The FFE microchip 1 further includes a plurality of outlet ports 19 which are each fluidly connected to a respective one of the outlet channels 17.

The FFE microchip 1 further includes first and second electrode units 21, 23 which are disposed at respective ones of the other, lateral sides of the separation chamber 5 for enabling the application of an electric field across the separation chamber 5 in a second, electric field direction which is orthogonal to the first, flow direction.

The electrode units 21, 23 each comprise an electrolyte reservoir 25 which is disposed adjacent the respective lateral side of the separation chamber 5 for containing a volume of an electrolyte solution, in this embodiment having the same length as the separation chamber 5, a plurality of connection channels 27, in this embodiment equi-spaced channels extending along the length of the respective lateral side of the separation chamber 5 and each having a width of 4 μm and a depth of 20 μm, which fluidly connect the electrolyte reservoir 25 to the respective lateral side of the separation chamber 5, and an electrode 29 which is disposed in the electrolyte reservoir 25. With this configuration, the connection channels 27 function in the manner of a membrane, thereby avoiding the need for separate membranes, and electrical connection is maintained between the electrodes 29, 29 and the separation chamber 5 in a manner which provides for a uniform electric field over the entire separation region.

The FFE microchip 1 further includes a magnet 31 for providing a magnetic field in a third, magnetic field direction which is orthogonal to the second, electrical field direction. The magnet 31 is at least substantially co-extensive with the separation chamber 5, and in this embodiment extends across the width of the FFE microchip 1 and over the length of the separation chamber 5. In this embodiment the magnet 31 is a high-permeability Ni (81%)-Fe (19%) permalloy magnet.

With this configuration, where orthogonal magnetic and electric fields are applied to the separation medium as an electrolyte solution, a Lorentz force is generated which acts to induce a magnetohydrodynamic flow of the separation medium, which is such as to develop a laminar flow through the separation chamber 5.

For this configuration, the average linear velocity ν of the pumped separation medium can be derived as:

ν=JB(h₂/16η) (1)

### Where:

J is the current density;
B is the magnetic field strength;
h is the depth of the separation chamber 5; and
η is the viscosity of the separation medium.

The FFE microchip 1 is fabricated from two planar plates, in this embodiment a plain glass substrate and a micromachined poly (dimethylsiloxane) (PDMS) layer. The fabrication of the PDMS layer, which defines the separation chamber 5, the channels 7, 9, 17, 27 and the reservoirs 11, 13, 25, 25 of the E microchip 1, was performed in a number of steps. In a first step, the chip layout was transferred onto a glass wafer having a coating of positive photoresist and chromium (Nanofilm, Westlake Village, Calif., US) using a laser writing system. In a second step, the chromium was etched to provide a chromium mask defining the chip layout. In a third step, a plain glass wafer was spin-coated with a negative photoresist (XP SU-8 10, MicroChem Corporation, Newton, Mass., US) to provide an SU-8 master mask; the spinning speed determining the thickness of the coating and hence the depth of the separation chamber 5 and the channels 7, 9, 17, 27. In a fourth step, the transparent pattern on the chromium mask was then transferred to the master mask by disposing the chromium mask on the master mask and exposing the master mask using a collimated UV light beam. In a fifth step, the unexposed SU-8 was flushed from the master mask with an SU-8 developer, leaving the SU-8 structures on the surface of the master mask. In a sixth step, PDMS base and curing agents (Sylgard 184, Dow Corning, Wiesbaden, Germany) were mixed in a 10:1 ratio and poured onto the master mask, and the resulting PDMS layer cured, typically at 40° C. In a seventh and final PDMS layer-forming step, large slots and holes were cut into the PDMS layer to form openings which define the reservoirs 11, 13, 25, 25 and the outlet ports 19. A layer of Ni (81%)-Fe (19%) permalloy was then electroplated on the glass layer so as provide the magnet 31. The PDMS layer and the glass substrate were then assembled, and lengths of platinum wire located in the electrolyte reservoirs 25, 25 to provide the electrodes 29, 29.

The separation system further comprises a plurality of collection units 36 which are fluidly connected to respective ones of the outlet ports 19 in the FFE microchip 1 by respective collection lines 37 for the collection of the components which are separated in the separation chamber 5, these components being presented to respective ones of the inlets of the outlet channels 17 in dependence upon the electrophoretic mobilities of the components. For ease of illustration, FIG. 1 illustrates only one of the collection units 36, whereas in practice collection units 36 would be connected to each of the outlet ports 19 in the FFE microchip 1. In an alternative embodiment the collection units 36 can be omitted, where collection of the separated components is not required.

The separation system further comprises a high-voltage supply 38 for applying an electrical potential between the electrodes 29, 29 of the electrode units 21, 23, and thereby developing an electric field across the separation chamber 5.

The separation system further comprises a detection unit 39 for detecting components driven through each of the outlet channels 17, and thereby enables the counting of the numbers of separated components. The detection unit 39 comprises a light source for illuminating a detection region of each of the outlet channels 17, and an optical detector for detecting the migration of components through each of the detection regions, in this embodiment by detecting the optical emission of the components. In alternative embodiments the detection unit 39 could comprise an electrochemical or biochemical detector.

The separation system further comprises a data acquisition unit 41 which is connected to the detection unit 39 for logging the output signal thereof.

The separation system further comprises a processing unit 43, in this embodiment a personal computer, for controlling the high-voltage supply 38, the detection unit 39 and the data acquisition unit 41, in this embodiment from a LabView program (National Instruments, Austin, Tex., US), and operating on the acquired data.

In use, flows of separation medium and sample are developed in the separation chamber 5 on the application of an electric field across the separation chamber 5, with the flows being driven by the Lorentz force resulting from the interaction of the electric and magnetic fields.

By virtue of the electric field across the separation chamber 5, the charged components in the sample deviate from the direction of the laminar flow in dependence upon the electrophoretic mobilities of the components, with the greater the electrophoretic mobility, the greater the extent of the lateral deflection.

Following separation of the components by the applied electric field, the components of different electrophoretic mobility are presented opposite different ones of the outlet channels 17, such that the components pass into respective ones of the outlet channels 17.

As the components pass the detection regions in each of the outlet channels 17, the detection unit 39 acts to detect the components, thereby enabling the numbers of each of the components to be counted.

The separated components are then collected in the respective collection units 36, which components can be subsequently utilized. As mentioned hereinabove, the collection units 36 can be omitted, whereby the material drawn through the FFE microchip 1 can be exhausted to waste.

FIGS. 3 and 4 illustrate a free flow electrophoresis separation system in accordance with a second embodiment of the present invention.

The separation system comprises a free flow electrophoresis (FFE) microchip 1 into which a sample containing charged components is introduced for the electrophoretic separation of the charged components, with the separation being in dependence upon the electrophoretic mobilities of the charged components.

The FFE microchip 1 includes a free flow separation chamber 5, in this embodiment a planar chamber of rectangular section and having a width of 14 mm, a length of 20 mm and a depth of 20 μm, in which a laminar flow of a separation medium is maintained and a sample containing charged components is introduced for electrophoretic separation. In this embodiment the separation chamber 5 includes a plurality of regularly-spaced posts, here 20 μm square, which act to support the structure of the separation chamber 5. In other embodiments the separation chamber 5 can have a depth of from about 5 μm to about 50 μm.

The FFE microchip 1 further includes a plurality of parallel inlet channels 7, 9, in this embodiment each having a width of 20 μm and a depth of 20 μm, the outlets of which are fluidly connected to one, inlet side of the separation chamber 5. One of the inlet channels 7, 9 defines a sample inlet channel 7 through which a flow of a sample containing charged components is introduced into the separation chamber 5. The others of the inlet channels 7, 9 define separation medium inlet channels 9, the outlets of which are in this embodiment equi-spaced, through which parallel flows of the separation medium are introduced into the separation chamber 5, thereby developing a laminar flow having a first, flow direction through the separation chamber 5. In this embodiment the sample inlet channel 7 is a channel central to the separation chamber 5, with ones of the separation medium inlet channels 9 being disposed to adjacent sides of the sample inlet channel 7.

As illustrated diagrammatically in FIG. 3, this configuration enables the separation of differently-charged components. In the separation of electrically-charged components, positively-charged components are deflected laterally to one lateral side, the cathode, relative to the flow of sample and negatively-charged components are deflected laterally to the other lateral side, the anode, relative to the flow of sample.

In another embodiment the sample inlet channel 7 could be disposed to one end of the inlet side of the separation chamber 5; this configuration being suited to applications where the components to be separated have one of a positive or negative charge, and hence are deflected only to one side of the flow of sample.

The FFE microchip 1 further includes a sample inlet port 11 to which the sample inlet channel 7 is fluidly connected, and a separation medium inlet port 13 to which the separation medium inlet channels 9 are commonly fluidly connected. In this embodiment the FFE microchip 1 includes first and second manifold channels 15, 15 which fluidly connect the respective ones of the separation medium inlet channels 9 disposed to each side of the sample inlet channel 7.

The FFE microchip 1 further includes a plurality of outlet channels 17, in this embodiment having a width of 20 μm and a depth of 20 μm, the inlets of which are fluidly connected to another, outlet side of the separation chamber 5 disposed opposite the inlet side of the separation chamber 5 to which the inlet channels 7, 9 are fluidly connected. In this embodiment the inlets of the outlet channels 17 are equi-spaced.

The FFE microchip 1 further includes a plurality of outlet ports 19 which are each fluidly connected to a respective one of the outlet channels 17.

The FFE microchip 1 further includes first and second electrode units 21, 23 which are disposed at respective ones of the other, lateral sides of the separation chamber 5, which electrode units 21, 23 are intended to assist in rendering an electric field induced across the separation chamber 5 uniform over the entire separation region. In an alternative embodiment the electrode units 21, 23 could be omitted.

The electrode units 21, 23 each comprise an electrolyte reservoir 25 which is disposed adjacent the respective lateral side of the separation chamber 5 for containing a volume of an electrolyte solution, in this embodiment having the same length as the separation chamber 5, a plurality of connection channels 27, in this embodiment equi-spaced channels extending along the length of the respective lateral side of the separation chamber 5 and each having a width of 4 μm and a depth of 20 μm, which fluidly connect the electrolyte reservoir 25 to the respective lateral side of the separation chamber 5, and an electrode 29 which is disposed in the electrolyte reservoir 25. With this configuration, the connection channels 27 function in the manner of a membrane, thereby avoiding the need for separate membranes, and electrical connection is maintained between the electrodes 29, 29 and the separation chamber 5 in a manner which assists in providing a uniform electric field over the entire separation region.

The FFE microchip 1 further includes a magnet 31 for providing a magnetic field in a second, magnetic field direction which is orthogonal to the first, flow direction through the separation chamber 5. The magnet 31 is at least substantially co-extensive with the separation chamber 5, and in this embodiment extends across the width of the FFE microchip 1 and over the length of the separation chamber 5. In this embodiment the magnet 31 is a high-permeability Ni (81%)-Fe (19%) permalloy magnet.

The FFE microchip 1 is fabricated from two planar plates, in this embodiment a plain glass substrate and a micromachined poly (dimethylsiloxane) (PDMS) layer. The fabrication of the PDMS layer, which defines the separation chamber 5, the channels 7, 9, 15, 17, 27, 27 and the reservoirs 25, 25 of the FFE microchip 1, was performed in a number of steps. In a first step, the chip layout was transferred onto a glass wafer having a coating of positive photoresist and chromium (Nanofilm, Westlake Village, Calif., US) using a laser writing system. In a second step, the chromium was etched to provide a chromium mask defining the chip layout. In a third step, a plain glass wafer was spin-coated with a negative photoresist (XP SU-8 10, MicroChem Corporation, Newton, Mass., US) to provide an SU-8 master mask; the spinning speed determining the thickness of the coating and hence the depth of the separation chamber 5 and the channels 7, 9, 15, 17, 27, 27. In a fourth step, the transparent pattern on the chromium mask was then transferred to the master mask by disposing the chromium mask on the master mask and exposing the master mask using a collimated UV light beam. In a fifth step, the unexposed SU-8 was flushed from the master mask with an SU-8 developer, leaving the SU-8 structures on the surface of the master mask. In a sixth step, PDMS base and curing agents (Sylgard 184, Dow Corning, Wiesbaden, Germany) were mixed in a 10:1 ratio and poured onto the master mask, and the resulting PDMS layer cured, typically at 40° C. In a seventh and final PDMS layer-forming step, large slots were cut into the PDMS layer to form openings which define the reservoirs 25, 25. Holes were then bored into the glass layer so as to provide the openings which define the inlet and outlet ports 11, 13, 19. A layer of Ni (81%)-Fe (19%) permalloy was then electroplated on the glass layer so as provide the magnet 31. The PDMS layer and the glass substrate were then assembled, and lengths of platinum wire located in the electrolyte reservoirs 25, 25 to provide the electrodes 29, 29.

The separation system further comprises a first, sample transfer unit 32, in this embodiment a delivery pump, which is fluidly connected to the sample inlet port 11 in the FFE microchip 1 by a first, sample transfer line 33 and operable to provide a flow of sample through the sample inlet channel 7 and into the separation chamber 5. The sample transfer unit 32 is operable such as to enable control of the flow rate of the sample provided to the separation chamber 5 in the FFE microchip 1.

The separation system further comprises a second, separation medium transfer unit 34, in this embodiment a delivery pump, which is fluidly connected to the separation medium inlet port 13 in the FFE microchip 1 by a second, separation medium transfer line 35 and operable to deliver flows of separation medium through the separation medium inlet channels 9 and into the separation chamber 5 as parallel liquid flows to develop a laminar flow. The separation medium transfer unit 34 is operable such as to enable control of the flow rate of the delivered separation medium.

With this configuration, where a magnetic field acts in a direction orthogonal to a hydrodynamic flow of the separation medium as an electrolyte solution, an electric field is induced in a third, electric field direction which is orthogonal both to the first, flow direction and the second, magnetic field direction, that is, in a direction transverse the separation chamber 5, which electric field provides for the electrophoretic separation of the charged components in the sample.

For this configuration, the induced electric field E can be derived as:

E=16ην/κh²B (2)

### Where:

η is the viscosity of the separation medium;

ν is the average linear velocity of the separation medium;

κ is the electrical conductivity of the separation medium;

h is the depth of the separation chamber 5; and

B is the magnetic field strength.

The separation system further comprises a plurality of collection units 36 which are fluidly connected to respective ones of the outlet ports 19 in the FFE microchip 1 by respective collection lines 37 for the collection of the components which are separated in the separation chamber 5, these components being presented to respective ones of the inlets of the outlet channels 17 in dependence upon the electrophoretic mobilities of the components. For ease of illustration, FIG. 3 illustrates only one of the collection units 36, whereas in practice collection units 36 would be connected to each of the outlet ports 19 in the FFE microchip 1. In an alternative embodiment the collection units 36 can be omitted, where collection of the separated components is not required.

The separation system further comprises a detection unit 39 for detecting components driven through each of the outlet channels 17, and thereby enables the counting of the numbers of separated components. The detection unit 39 comprises a light source for illuminating a detection region of each of the outlet channels 17, and an optical detector for detecting the migration of components through each of the detection regions, in this embodiment by detecting the optical emission of the components. In alternative embodiments the detection unit 39 could comprise an electrochemical or biochemical detector.

The separation system further comprises a data acquisition unit 41 which is connected to the detection unit 39 for logging the output signal thereof.

The separation system further comprises a processing unit 43, in this embodiment a personal computer, for controlling the sample transfer unit 32, the separation medium transfer unit 34, the detection unit 39 and the data acquisition unit 41, in this embodiment from a LabView program (National Instruments, Austin, Tex., US), and operating on the acquired data.

In use, flows of sample and separation medium are driven through the separation chamber 5 by respective ones of the sample transfer unit 32 and the separation medium transfer unit 34.

By virtue of the magnetic field which is in a direction orthogonal to the flow direction through the separation chamber 5, an electric field is induced which is transverse to the separation chamber 5, that is, orthogonal to the flow direction. This electric field acts to deflect the charged components in the sample from the flow direction in dependence upon the electrophoretic mobilities of the components, with the greater the electrophoretic mobility, the greater the extent of the lateral deflection.

Following separation of the components by the induced electric field, the components of different electrophoretic mobility are presented opposite different ones of the outlet channels 17, such that the components pass into respective ones of the outlet channels 17.

As the components pass the detection regions in each of the outlet channels 17, the detection unit 39 acts to detect the components, thereby enabling the numbers of each of the components to be counted.

The separated components are then collected in the respective collection units 36, which components can be subsequently utilized. As mentioned hereinabove, the collection units 36 can be omitted, whereby the material drawn through the FFE microchip 1 can be exhausted to waste.

Finally, it will be understood that the present invention has been described in its preferred embodiments and can be modified in many different ways without departing from the scope of the invention as defined by the appended claims.

For example, the separation systems of the described embodiments can be equally utilized for iso-electric focussing. In iso-electric focussing, charged components are separated according to their iso-electric points, where components having a high iso-electric point migrate towards the cathode until the charge is neutralised by the OH⁻ ions and components having a low iso-electric point migrate towards the anode until the charge is neutralised by the H⁺ ions.

FIG. 5 schematically illustrates a free flow electrophoresis separation system as a modification of the above-described first embodiment for iso-electric focusing, where the separation medium comprises a plurality of ampholines which have different iso-electric points and provide for the establishment of a pH gradient in the separation chamber 5 transverse to the flow direction therethrough.

In this modification, the FFE microchip 1 differs only in that the separation medium inlet channels 9 are not commonly fluidly connected to a single separation medium reservoir 13, but rather each inlet channel 9a-h is connected to a separate reservoir 13a-h for containing an ampholine having a different iso-electric point, whereby a pH gradient is established across the separation chamber 5.

Operation is the same as for the above-described first embodiment, where charged components are separated according to their iso-electric points, with the components migrating in the electric field until the components reach the iso-electric points in the pH gradient where, having lost net charge, the components are focused.

FIG. 6 schematically illustrates a free flow electrophoresis separation system as a modification of the above-described second embodiment for iso-electric focusing, where the separation medium comprises a plurality of ampholines which have different iso-electric points and provide for the establishment of a pH gradient in the separation chamber 5 transverse to the flow direction therethrough.

In this modification, the free flow electrophoresis separation system differs only in that the separation medium inlet channels 9 are not commonly fluidly connected to a single separation medium transfer unit 34, but rather each separation medium inlet channel 9a-h is connected to a separate transfer unit 34a-h for providing separate ampholine flows having different iso-electric points, whereby a pH gradient is established across the separation chamber 5.

Operation is the same as for the above-described second embodiment, where charged components are separated according to their iso-electric points, with the components migrating in the electric field until the components reach the iso-electric points in the pH gradient where, having lost net charge, the components are focused.

In further modifications of the above-described modifications, the separation medium could comprise a plurality of ampholines which have different iso-electric points, and the separation medium inlet channels 9 could be commonly fluidly connected to a single separation medium reservoir 13, where the different ampholines migrate in the electric field to lateral positions in the separation chamber 5 according to their iso-electric point.

1. A free flow electrophoresis microchip, comprising:
a separation chamber in which charged components are in use separated;
a plurality of separation medium inlet channels having outlets fluidly connected to one, inlet side of the separation chamber through which flows of a separation medium are in use introduced into the separation chamber such as to develop a laminar flow having a flow direction through the separation chamber;
a sample inlet channel having an outlet fluidly connected to the inlet side of the separation chamber through which a flow of a sample containing charged components is in use introduced into the separation chamber;
a plurality of outlet channels having inlets fluidly connected to another, outlet side of the separation chamber opposite the inlet side thereof; and
a magnetic field unit for providing a magnetic field substantially orthogonal to the flow direction of the separation medium;
whereby charged components introduced into the separation chamber are deflected laterally across the separation chamber in dependence upon the charge of the charged components.

2. The microchip of claim 1, wherein the outlets of the separation medium inlet channels are disposed in spaced relation along the inlet side of the separation chamber.

3. The microchip of claim 1, wherein the outlet of the sample inlet channel is disposed in a central region of the inlet side of the separation chamber.

4. The microchip of claim 1, wherein the outlet of the sample inlet channel is disposed in an end region of the inlet side of the separation chamber.

5. The microchip of claims 1, wherein the outlets of the sample inlet channel and the separation medium inlet channels face in the same direction.

6. The microchip of claim 1, wherein the separation medium inlet channels are commonly fluidly connected.

7. The microchip of claim 1, wherein groups of ones of the separation medium inlet channels are commonly fluidly connected.

8. The microchip of claim 1, wherein the separation medium inlet channels are separately fluidly connected.

9. The microchip of claim 1, wherein the outlets of the sample inlet channel and the separation medium inlet channels are disposed in opposed relation to the inlets of the outlet channels.

10. The microchip of claim 1, wherein the inlets of the outlet channels have a depth at least as great as that of the separation chamber.

11. The microchip of claim 1, wherein the inlets of the outlet channels are disposed in spaced relation along the outlet side of the separation chamber.

12. The microchip of claim 11, wherein the inlets of the outlet channels are equi-spaced.

13. The microchip of claim 1, wherein the separation chamber comprises a planar chamber having a planar region.

14. The microchip of claim 13, wherein the magnetic field is directed substantially orthogonally to the planar region of the separation chamber.

15. The microchip of claim 13, wherein the separation chamber has a depth of from about 5 μm to about 50 μm.

16. The microchip of claim 1, wherein the magnetic field unit comprises at least one magnet.

17. The microchip of claim 16, wherein the at least one magnet comprises a layer of magnetic material.

18. The microchip of claim 17, wherein the magnetic material comprises a Ni—Fe permalloy.

19. The microchip of claim 1, further comprising:
first and second electrode units disposed at respective ones of other, lateral sides of the separation chamber.

20. The microchip of claim 19, wherein the electrode units each comprise an electrolyte reservoir disposed adjacent the respective lateral side of the separation chamber for containing a volume of an electrolyte medium, and a plurality of connection channels fluidly connecting the electrolyte reservoir to the respective lateral side of the separation chamber.

21. The microchip of claim 20, wherein each electrolyte reservoir has substantially the same length as the separation chamber.

22. The microchip of claim 20, wherein the connection channels are disposed in spaced relation along the respective lateral sides of the separation chamber.

23. The microchip of claim 22, wherein the connection channels are equi-spaced.

24. The microchip of claim 20, wherein the connection channels have a width of from about 1 μm to about 5 μm.

25. The microchip of claim 20, wherein the electrode units each further comprise an electrode element disposed in the respective electrolyte reservoir.

26. A free flow electrophoresis separation system, comprising:
the free flow electrophoresis microchip of claim 19; and
a high-voltage supply for applying an electric field between the electrode units and across the separation chamber in a direction substantially orthogonal to the magnetic field;
whereby a magnetohydrodynamic flow of sample and separation medium is induced through the separation chamber.

27. A free flow electrophoresis separation system, comprising:
the free flow electrophoresis microchip of claim 1; and
a supply unit for supplying flows of sample and separation medium through the respective ones of the sample inlet channel and the separation medium inlet channels and into the separation chamber;
whereby an electric field is induced across the separation chamber in a direction substantially orthogonal to the flow direction.

28. The system of claim 27, wherein the supply unit comprises a first transfer unit fluidly connected to the sample inlet channel for delivering a flow of sample through the sample inlet channel and into the separation chamber, and at least one second transfer unit fluidly connected to the separation medium inlet channels for delivering flows of separation medium through the separation medium inlet channels and into the separation chamber.

29. The system of claim 28, wherein at least one of the first transfer unit and the at least one second transfer unit are operable to control flow rates of the sample and separation medium flows to the separation chamber.

30. The system of claim 28, wherein the at least one second transfer unit comprises a plurality of second transfer units fluidly connected to respective ones of the separation medium inlet channels.

31. The system of claim 30, wherein the plurality of second transfer units are fluidly connected to groups of ones of the separation medium inlet channels.

32. The system of claim 30, wherein the plurality of second transfer units are fluidly connected to separate ones of the separation medium inlet channels.

33. The system of claim 28, wherein each transfer unit comprises a delivery pump.

34. The system of claim 26, further comprising:
at least one collection unit fluidly connected to at least one of the outlet channels for collection of at least one separated component.

35. The system of claim 34, comprising:
a plurality of collection units fluidly connected to respective ones of the outlet channels for collection of a plurality of separated components.

36. The system of claim 26, further comprising:
a detection unit for detecting migration of at least one separated component through at least one of the outlet channels.

37. The system of claim 36, wherein the detection unit is configured to detect migration of separated components through a plurality of ones of the outlet channels.

38. The system of claim 37, wherein the detection unit is configured to detect migration of separated components through each of the outlet channels.

39. A free flow electrophoresis method of separating charged components, the method comprising the steps of:
providing a free flow electrophoresis microchip, comprising: a separation chamber in which charged components are separated; a plurality of separation medium inlet channels having outlets fluidly connected to one, inlet side of the separation chamber; a sample inlet channel having an outlet fluidly connected to the inlet side of the separation chamber; a plurality of outlet channels having inlets fluidly connected to another, outlet side of the separation chamber opposite the inlet side thereof; a magnetic field unit for providing a magnetic field in a direction substantially orthogonal to the flow direction of the separation medium;
and first and second electrode units disposed at respective ones of other, lateral sides of the separation chamber; and
applying a potential between the electrode units so as to generate an electric field across the separation chamber in a direction substantially orthogonal to the magnetic field direction, wherein the electric field acts together with the magnetic field to induce a magnetohydrodynamic flow of sample and separation medium through the separation chamber, and deflect the charged components laterally across the separation chamber in dependence upon the charge of the charged components.

40. The method of claim 39, wherein the outlets of the separation medium inlet channels are disposed in spaced relation along the inlet side of the separation chamber.

41. The method of claim 39, wherein the outlet of the sample inlet channel is disposed in a central region of the inlet side of the separation chamber.

42. The method of claim 39, wherein the outlet of the sample inlet channel is disposed in an end region of the inlet side of the separation chamber.

43. The method of claim 39, wherein the outlets of the sample inlet channel and the separation medium inlet channels face in the same direction.

44. The method of claim 39, further comprising the step of:
commonly introducing separation medium through the separation medium inlet channels.

45. The method of claim 39, further comprising the step of:
introducing different separation media through respective groups of ones of the separation medium inlet channels.

46. The method of claim 39, further comprising the step of:
introducing different separation media through respective ones of the separation medium inlet channels.

47. The method of claim 39, wherein the outlets of the sample inlet channel and the separation medium inlet channels are disposed in opposed relation to the inlets of the outlet channels.

48. The method of claim 39, wherein the inlets of the outlet channels have a depth at least as great as that of the separation chamber.

49. The method of claim 39, wherein the inlets of the outlet channels are disposed in spaced relation along the outlet side of the separation chamber.

50. The method of claim 49, wherein the inlets of the outlet channels are equi-spaced.

51. The method of claim 39, wherein the separation chamber comprises a planar chamber having a planar region.

52. The method of claim 51, wherein the magnetic field direction is in a direction substantially orthogonal to the planar region of the separation chamber.

53. The method of claim 51, wherein the separation chamber has a depth of from about 5 μm to about 50 μm.

54. The method of claim 39, wherein the magnetic field unit comprises at least one magnet.

55. The method of claim 54, wherein the at least one magnet comprises a layer of magnetic material.

56. The method of claim 55, wherein the magnetic material comprises a Ni—Fe permalloy.

57. The method of claim 39, wherein the electrode units each comprise an electrolyte reservoir disposed adjacent the respective lateral side of the separation chamber for containing a volume of an electrolyte medium, and a plurality of connection channels fluidly connecting the electrolyte reservoir to the respective lateral side of the separation chamber.

58. The method of claim 57, wherein each electrolyte reservoir has substantially the same length as the separation chamber.

59. The method of claim 57, wherein the connection channels are disposed in spaced relation along the respective lateral sides of the separation chamber.

60. The method of claim 59, wherein the connection channels are equi-spaced.

61. The method of claim 57, wherein the connection channels have a width of from about 1 μm to about 5 μm.

62. The method of claim 57, wherein the electrode units each further comprise an electrode element disposed in the respective electrolyte reservoir.

63. The method of claim 39, further comprising the step of:
collecting at least one separated component from at least one of the outlet channels.

64. The method of claim 63, wherein the step of collecting at least one separated component comprises the step of:
collecting separated components from respective ones of the outlet channels.

65. The method of claims 39, further comprising the step of:
detecting migration of at least one separated component through at least one of the outlet channels.

66. The method of claim 65, wherein the step of detecting migration of at least one separated component comprises the step of:
detecting migration of separated components through a plurality of ones of the outlet channels.

67. The method of claim 66, wherein the step of detecting migration of at least one separated component comprises the step of:
detecting migration of separated components through each of the outlet channels.

68. A free flow electrophoresis method of separating charged components, the method comprising the steps of:
providing a free flow electrophoresis microchip, comprising: a separation chamber in which charged components are separated; a plurality of separation medium inlet channels having outlets fluidly connected to one, inlet side of the separation chamber; a sample inlet channel having an outlet fluidly connected to the inlet side of the separation chamber; a plurality of outlet channels having inlets fluidly connected to another, outlet side of the separation chamber opposite the inlet side thereof; and a magnetic field unit for providing a magnetic field in a direction substantially orthogonal to the flow direction of the separation medium; and
supplying flows of sample and separation medium through the respective ones of the sample inlet channel and the separation medium inlet channels into and through the separation chamber, wherein the flow of separation medium acts together with the magnetic field to induce an electric field across the separation chamber in a direction substantially orthogonal to the flow direction, which electric field acts to deflect the charged components laterally across the separation chamber in dependence upon the charge of the charged components.

69. The method of claim 68, wherein the outlets of the separation medium inlet channels are disposed in spaced relation along the inlet side of the separation chamber.

70. The method of claim 68, wherein the outlet of the sample inlet channel is disposed in a central region of the inlet side of the separation chamber.

71. The method of claim 68, wherein the outlet of the sample inlet channel is disposed in an end region of the inlet side of the separation chamber.

72. The method of claims 68, wherein the outlets of the sample inlet channel and the separation medium inlet channels face in the same direction.

73. The method of claim 68, wherein the step of supplying sample and separation medium includes the step of:
commonly supplying separation medium through the separation medium inlet channels.

74. The method of claim 68, wherein the step of supplying sample and separation medium includes the step of:
supplying different separation media through respective groups of ones of the separation medium inlet channels.

75. The method of claim 68, wherein the step of supplying sample and separation medium includes the step of:
supplying different separation media through respective ones of the separation medium inlet channels.

76. The method of claim 68, wherein the step of supplying sample and separation medium comprises the step of:
delivering sample and separation medium flows through the respective ones of the sample inlet channel and the separation medium inlet channels and into the separation chamber.

77. The method of claim 68, wherein flow rates of the sample and separation medium flows are regulated to control the lateral deflection of the charged components.

78. The method of claim 68, wherein the outlets of the sample inlet channel and the separation medium inlet channels are disposed in opposed relation to the inlets of the outlet channels.

79. The method of claim 68, wherein the inlets of the outlet channels have a depth at least as great as that of the separation chamber.

80. The method of claim 68, wherein the inlets of the outlet channels are disposed in spaced relation along the outlet side of the separation chamber.

81. The method of claim 80, wherein the inlets of the outlet channels are equi-spaced.

82. The method of claim 68, wherein the separation chamber comprises a planar chamber having a planar region.

83. The method of claim 82, wherein the magnetic field direction is in a direction substantially orthogonal to the planar region of the separation chamber.

84. The method of claim 82, wherein the separation chamber has a depth of from about 5 μm to about 50 μm.

85. The method of claim 68, wherein the magnetic field unit comprises at least one magnet.

86. The method of claim 85, wherein the at least one magnet comprises a layer of magnetic material.

87. The method of claim 86, wherein the magnetic material comprises a Ni—Fe permalloy.

88. The method of claim 68, wherein the microchip further comprises: first and second electrode units disposed at respective ones of other, lateral sides of the separation chamber.

89. The method of claim 88, wherein the electrode units each comprise an electrolyte reservoir disposed adjacent the respective lateral side of the separation chamber for containing a volume of an electrolyte medium, and a plurality of connection channels fluidly connecting the electrolyte reservoir to the respective lateral side of the separation chamber.

90. The method of claim 89, wherein each electrolyte reservoir has substantially the same length as the separation chamber.

91. The method of claim 89, wherein the connection channels are disposed in spaced relation along the respective lateral sides of the separation chamber.

92. The method of claim 91, wherein the connection channels are equi-spaced.

93. The method of claim 89, wherein the connection channels have a width of from about 1 μm to about 5 μm.

94. The method of claim 89, wherein the electrode units each further comprise an electrode element disposed in the respective electrolyte reservoir.

95. The method of claim 68, further comprising the step of:
collecting at least one separated component from at least one of the outlet channels.

96. The method of claim 95, wherein the step of collecting at least one separated component comprises the step of:
collecting separated components from respective ones of the outlet channels.

97. The method of claim 68, further comprising the step of:
detecting migration of at least one separated component through at least one of the outlet channels.

98. The method of claim 97, wherein the step of detecting migration of at least one separated component comprises the step of:
detecting migration of separated components through a plurality of ones of the outlet channels.

99. The method of claim 98, wherein the step of detecting migration of at least one separated component comprises the step of:
detecting migration of separated components through each of the outlet channels.
